(19) United States
(12) Patent Application Publication
(10) Pub. No.: US 2015/0199183 A1
(43) Pub. Date: Jul. 16, 2015

(54) PROGRAM ANALYSIS APPARATUS AND PROGRAM ANALYSIS METHOD

(71) Applicant: Hitachi, Ltd., Tokyo (JP)

(72) Inventors: Yuichiro NAKAGAWA, Tokyo (JP); Yasufumi SUZUKI, Tokyo (JP); Makoto ICHII, Tokyo (JP); Hideto NOGUCHI, Tokyo (JP)

(73) Assignee: HITACHI, LTD., Tokyo (JP)

(21) Appl. No.: 14/595,413

(22) Filed: Jan. 13, 2015

(30) Foreign Application Priority Data
Jan. 15, 2014 (JP) 2014-004781

(51) Int. Cl. G06F 9/44

(52) U.S. Cl. CPC G06F 8/36

(57) ABSTRACT

An object is to assist analysis work on a program in software development and improve program development efficiency. A program analysis apparatus performs symbolic-execution on a program stored in a storage device, receives an input of a change point of the program, and based on a result of the symbolic-execution, identifies an influenced segment of the program when the program is changed for the change point. The program analysis apparatus receives the change point by receiving a change operation on any one of a symbolic summary which is a terminal node of an execution tree obtained by the symbolic-execution, a decision table based on the symbolic summary, and a source code. The program analysis apparatus visualizes the influenced segment of the identified program in any mode of the symbolic summary, the source code, and the decision table.

### CROSS-REFERENCE TO RELATED APPLICATION

The present application claims the benefit of priority pursuant to 35 U.S.C. §119(a) to Japanese Patent Application No. 2014-4781, filed on Jan. 15, 2014, the entire disclosure of which is hereby incorporated herein by reference.

### BACKGROUND OF THE INVENTION

1. Field of the Invention

The present invention relates to a program analysis apparatus and a program analysis method.

2. Related Art

Japanese Patent Application Laid-open Publication No. 2012-68869 discloses that “An iterative symbolic-execution method includes: a first execution step of causing a symbolic executor, configured to execute symbolic-execution, to iterate symbolic-execution while changing symbolic variables so as to cover all the variables defined in an analysis target program; an acquisition step of acquiring a code coverage of the analysis target program (for example, a branch coverage, a statement coverage, or the like) from the symbolic executor and storing the code coverage in an execution result storage part; a step of determining whether or not the code coverage stored in the execution result storage part meets a predetermined reference; and a step of storing data indicating that the test on the analysis target program is completed in an output data storage part when the code coverage is determined as meeting the predetermined reference.”

Nowadays, software development is often conducted on the condition that existing programs are reused. In particular, in large-scale infrastructure systems, many projects are performed as differential developments or derivation developments based on the existing programs which have been accumulated over years.

In such software development, what is important from the view point of achieving development efficiency, reliability, and the like is to effectively and correctly identify which parts of an existing program are influenced (a range to be influenced) by a modification for adapting the program to new specifications.

However, the influenced segments are conventionally identified mainly in such a manual way that full-text searching on the source code is performed for all variables written therein, and possible values of each of the variables are estimated from a conditional branch included in the source code. For example, when a reused program has a large scale and involves a wide variety of possible values of the variables used in the program and branch conditions described in the program, a huge labor is required to identify the influenced segments and it is difficult to secure the reliability of the program.

### SUMMARY OF THE INVENTION

The present invention is made in view of the foregoing background. Accordingly, an object of the present invention is to assist analysis work on a program in software development and thereby to improve the development efficiency of the program.

To achieve the above object, one aspect of the present invention provides a program analysis apparatus that includes a processor, a storage device, a symbolic-execution processing part to execute symbolic-execution on a program stored in the storage device, a change point reception part to receive an input of a change point of the program, and an influenced segment analysis part to identify, based on a result of the symbolic-execution, an influenced segment which is a segment of the program having a possibility of being influenced when the program is changed for the change point.

The present invention is able to assist analysis work of a program in software development and thereby improve the development efficiency of the program.

### BRIEF DESCRIPTION OF THE DRAWINGS

FIG. 1 is a diagram illustrating symbolic-execution; FIG. 2 is an example of an information processing system 1 configured by using a program analysis apparatus 10;

FIG. 3 is a flowchart for illustrating program analyzing processing S300;

FIG. 4 is an example illustrating an example designation screen 400 for a method of inputting a source code and a modification;

FIG. 5 is a diagram illustrating an example modification input receiving screen (symbolic summary) 500;

FIG. 6 is a diagram illustrating an example modification input receiving screen (decision table) 600;

FIG. 7 is a diagram illustrating an example modification input receiving screen (source code) 700;

FIG. 8 is a diagram illustrating example trace information 254;

FIG. 9 is a flowchart illustrating influenced segment analyzing processing S315;

FIG. 10 is a diagram illustrating an analysis result display screen 1000;

FIG. 11 is a diagram illustrating an analysis result display screen 1100;

FIG. 12 is a diagram illustrating an analysis result display screen 1200;

FIG. 13 is a diagram illustrating an analysis result display screen 1300;

FIG. 14 is a diagram illustrating an analysis result display screen 1400; and

FIG. 15 is a diagram illustrating an analysis result display screen 1500.

### DETAILED DESCRIPTION OF THE INVENTION

Hereinafter, embodiments are described by referring to the drawings. In the following description, same reference signs are given to denote same or similar portions, and the duplicated description may be omitted. Also, “program” is sometimes expressed as “PG.”

### Symbolic-Execution

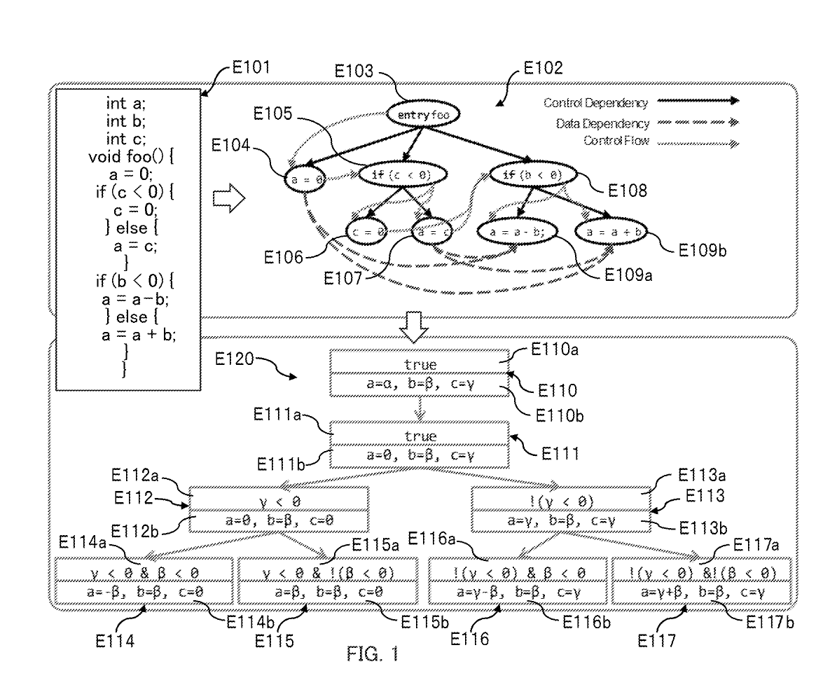

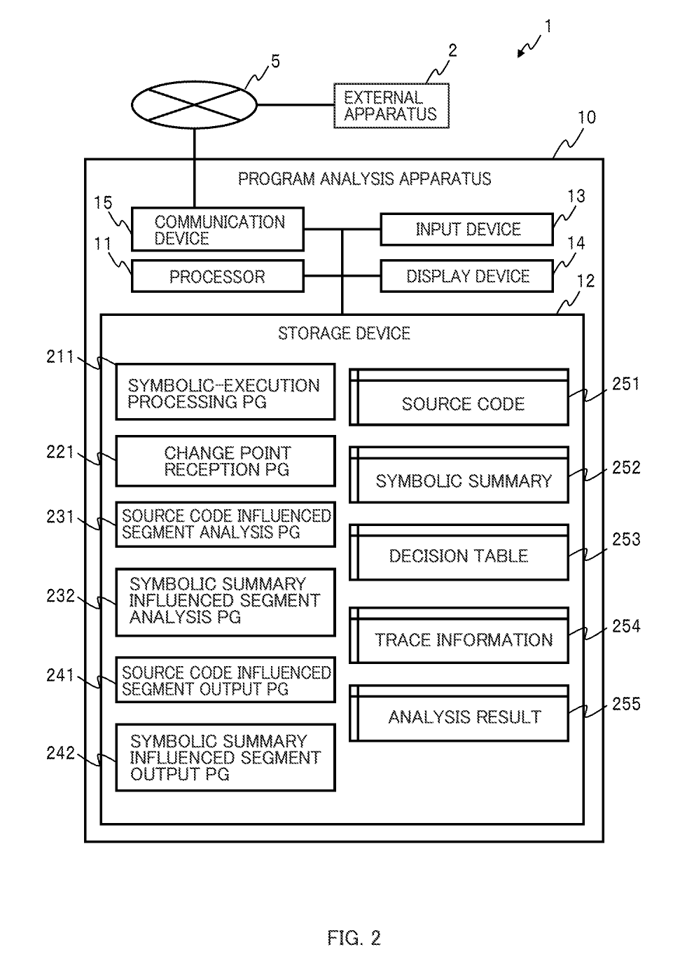

First of all, symbolic-execution which is a prerequisite technique for the present embodiment is described. The symbolic-execution is a technique of: executing a program by using symbols as variables (such as input variables and global variables) used in the program, instead of executing the program by substituting specific values into the variables; and finding, from all the control flows in the program, combinations (also referred to as nodes, below) for reaching each of the control flows, the nodes each including an conditional expression (also referred to as a path constraint below) and an expression in which the state of a variable in the execution process of the program (also referred to as a variable state, below) is expressed by using a symbol. The symbolic-execution can obtain correspondences between input values and output values of the variables in all the control flows of the program. Hereinafter, description is provided for the case where an information processing apparatus performs the symbolic-execution on a source code E101 written in the C language in FIG. 1.

In the symbolic-execution, the information processing apparatus performs a lexical analysis and a syntax analysis, as similar to those performed when compiling, on the source code E101, and thereby creates a structure graph illustrated by sign E102. Here, a solid arrow in FIG. 1 indicates a control dependency (Control Dependency), a dashed arrow indicates a data dependency (Data Dependency), and a dashed-dotted arrow indicates a control flow (Control Flow).

Subsequently, the information processing apparatus creates an execution tree illustrated by a sign E120 based on a structure graph E102. As illustrated in FIG. 1, each node of the execution tree E120 is expressed by a combination of the above-described path constraint (upper field) and variable state (lower field). A root node of the execution tree E120 corresponds to an initial state. The information processing apparatus adds a new node to the execution tree E120 every time the variable state is updated along with the program execution.

When the execution tree E120 is created, the information processing apparatus firstly substitutes symbolic variables into variables used in the source code E101. The example source code E101 has three input variables “a, ” “b, ” and “c.” In the example, the information processing apparatus sequentially substitutes “α, ” “β, ” and “γ” into the respective input variables as symbolic variables.

After that, the information processing apparatus creates a root node E110 for the execution tree E12 based on the node E103 of the structure graph E102. In the present example, the information processing apparatus sets “true” indicating “no constraint” (the conditions are held (true) for any variable states) in the path constraint (upper field) E110a of the root node E110 and sets “a=α,” “b=β,” and “c=γ” indicating that the symbolic variables “α,” “β,” and “γ” are respectively substituted for the input variables “a,” “b,” and “c” in the variable states (lower field) E110b.

Then, the information processing apparatus creates a child node E111 for the node E110 of the execution tree E120 based on the node E104 of the structure graph E102. As illustrated in FIG. 1, the information processing apparatus sets “true” which is the same as a path constraint E110a of a parent node E110 in a path constraint (upper field) E111a of a child node E111. In addition, since “0” is substituted for the variable a in the node E104 of the structure graph E102, the information processing apparatus sets “a=0, B=β, c=γ” in the variable state (lower field) E111b of the child node E111.

In the structure graph E102, the node E105 is executed after the node E104, but since a variable state is not updated in the node E105, a new node corresponding to that is not added to the execution tree E120. However, since the node E105 is a conditional branch by an if statement and the node E105 is followed by two nodes of a node E106 and a node E107 in the structure graph E102, the information processing apparatus creates a child node E112 corresponding to the node E106 and a child node E113 corresponding to a node E107 with respect to a node E111. In this manner, in the symbolic-execution, a child node corresponding to the conditional branch is created for the execution tree so that all the possible control flows are covered.

A logical product of a path constraint (upper field) E111a of the parent node E111 and the conditional expression of the node E105 is set for the path constraint (upper field) of the node E112. Here, the conditional expression in the node E105 is “c<0” and the variable state of the parent node E111 of the node E112 is “a=0, b=β, c=γ.” So, “γ” is obtained when the variable “c” is expressed by the symbolic variable. Accordingly, the conditional expression becomes “γ<0.” For this reason, the information processing apparatus sets “γ<0, ” which is the logical product of “true” and “γ<0, ” for the path constraint (upper field) E112a of the node E112. In addition, since “0” is substituted for the variable “c” in the node E106 of the structure graph E102, the information processing apparatus sets “a=0, b=β, c=0” for the variable state (lower field) E112b of the node E112.

The path constraint (upper field) E113a of the node E113 corresponds to the case where a determination result by the conditional expression of the node E105 becomes fault. For this reason, the information processing apparatus sets “! (γ<0) ” which is the logical product of “true,” which is the path constraint (upper field) of the parent node E111 and “! (γ<0) , ” which is negation of the conditional expression for the path constraint (upper field) E113a of the node E113 (the symbol “!” is expressed as negation. Also, since the value of the variable “c” is substituted for the variable “a” in the node E107 of the structure graph E102 and the variable state of the variable “c” is set to be the symbolic variable “γ” in the parent node E111, the information processing apparatus sets “a=γ, b=β, c=γ” for the variable state (lower field) E113b of the node E113.

In the structure graph E102, the node E106 is followed by a node E108. Since the node E108 has a conditional branch by an if statement, the information processing apparatus creates two child nodes of a child node E114 and a child node E115, which correspond to the true and fault of the decision results of the conditional expression of the node E108, for E112 of the execution tree E120.

The conditional expression of the node E108 of the structure graph E102 is (b<0). Also, since the variable state (lower field) E112b of the parent node E112 of the child node E114 and the child node E115 is “a=0, b=β, c=0,” the variable “b” is expressed by the symbolic variable “β” and the conditional expression becomes “β<0.” For this reason, the information processing apparatus respectively sets “γ<0 & β<0” which is the logical product of “γ=0” and “γ<0” and “γ=0 & !(β<0)” which is the logical product of “γ<0” and “! (β<0)” for the path constraint (upper field) E114a of the node E114 and the path constraint (upper field) E115a of the node E115.

In the node E109a of the structure graph E102, “a-b” is substituted for the variable “a,” and the variable “a” is “0” and the variable “b” is “β” and the variable “c” is “0” from the variable states (lower field) E112b of the parent node E112. Thus, the variable “a” becomes “a−b=0−β=−β.” For this reason, the information processing apparatus sets “a=−β, b=β, c=0” for the variable state (lower field) E114b of the node E114. In addition, “a+b” is substituted for the variable “a” in the node E 109b of the structure graph E102, and the variable “a” is “0” the variable “b” is “β” from the variable states of the parent node E112. Thus, the variable “a” becomes “a+b=0+β=β.” For this reason, the information processing apparatus sets “a=β, b=β, c=0” for the variable state (lower field) E115b of the node E115.

In the structure graph E102, the node E107 is followed by the node E108. The node E108 is a conditional branch by if statement. Thus, the information processing apparatus creates two child nodes of a node E116 and a node E117 for the node E113 of the execution tree E120.

The conditional expression of the node E108 is (b<0). Also, the variable state (lower field) E113b of the parent node E113 of the node E116 is “a=γ, b=β, c=γ” and the variable “b” is expressed by the symbolic variable “β” and the conditional expression becomes up “β<0.” For this reason, the information processing apparatus respectively sets “!(γ<0) & β<0” which is the logical product of “!(γ<0)” and “β<0” and “!(γ<0) & ! (β<0)” which is the logical product of “!(γ<0)” and “(β<0)” for the path constraint (upper field) E116a of the node E116 and the path constraint (upper field) E117a of the node E117.

In the node E109a of the structure graph E102, “a−b” is substituted for the variable “a” and “a=γ, b=β, C=γ” from the variable states (lower field) E113b of the parent node E113. Thus, the variable “a” becomes “a−b=γ−β.” For this reason, the information processing apparatus sets “a=γ−β, b=β, c=γ” for the variable state (lower field) E116b of the node E116. In addition, in the node E109b of the structure graph E102, “a+b” is substituted for the variable “a” and the variable is “a=y, b=β, C=γ” from the variable state (lower field) E113b of the parent node E113. Thus, the variable “a” becomes “a+b=γ+β.” For this reason, the information processing apparatus sets “a=γ+β, b=β, C=γ” for the variable state (lower field) E117b of the node E117.

In this manner, it can be said that the symbolic-execution is to obtain a relationship of the variable values before and after the program is executed and a set of pairs of conditions (path constraints) of the input values and the states of output variables (variable states) after covering all the control flows which can be performed by the program. It is to be noted that in the following description, a terminal node of the execution tree at the time point when the symbolic-execution is terminated is referred to as a “symbolic summary.” Any combination of the symbolic variations “α,” “β,” and “γ” meets the path constraints of any one of the symbolic summaries. Using the symbolic summary allows a value of each variable after executing the program to be unknown from the value of the symbolic variable to be an input. For example, when all values of the variables “a,” “b,” and “c” before executing the source code E101 is “1,” the symbolic variable becomes “α=β=γ=1,” which meets the path constraints E117a of the node E117. Accordingly, it can be seen from the variable state (lower field) E117b of the node E117 that the value of the variable of the source code E101 after execution becomes “a=γ+β=2, b=β=1, c=γ=1.”

### Program Analysis Apparatus

Described hereinafter is a program analysis apparatus 10 illustrated as one embodiment. The program analysis apparatus 10 receives an input of a change which is made along with a program modification from a user and executes a symbolic-execution for the program, so that an influenced segment of the received change in the program is visualized.

FIG. 2 illustrates an example of the information processing system 1 configured using the program analysis apparatus 10. The program analysis apparatus 10 is an information processing apparatus (computer) and includes a processor 11, a storage device 12, an input device 13, a display device 14, and a communication device 15. These devices are coupled communicatively to one another through a communication means such as a bus.

The processor 11 includes a CPU (Central Processing Unit) and MPU (Micro Processing Unit), for example. The processor 11 reads and executes a program stored in the storage device 12 to achieve a various kinds of functions of the program analysis apparatus 10.

The storage device 12 is a device to store programs and data, which is, for example, a ROM (Read Only Memory), a RAM (Random Access Memory), an NVRAM (Non Volatile RAM), a hard disk drive, an SSD (Solid State Drive), or an optical storage device.

The input device 13 is a user interface to receive an input of information and an instruction from a user, which is, for example, a keyboard, a mouse, or a touch panel . The display device 14 is a user interface to provide user with information, which is, for example, a liquid crystal monitor, or an LCD (Liquid Crystal Display). The communication device 15 is a communication interface to communicate with an external apparatus 2 through the communication network 5, which is, for example, an NIC (Network Interface Card).

As illustrated in FIG. 2, the storage device 12 stores a symbolic-execution processing PG 211, a change reception PG 221, a source code influenced segment analysis PG 231, a symbolic summary influenced segment analysis PG 232, a source code influenced segment output PG 241, and a symbolic summary influenced segment output PG 242. In the following description, functions achieved by these programs are sequentially referred to as a symbolic-execution processing part, a change point reception part, a source code influenced segment analysis part, a symbolic summary influenced segment analysis part, a source code influenced segment output part, and a symbolic summary influenced segment output part. As illustrated in FIG. 2, the storage device 12 stores a source code 251, symbolic summary 252, a decision table 253, trace information 254, and a analysis result 255 of a modification-targeted program.

The symbolic-execution processing part performs symbolic-execution on the modification-targeted program and creates the symbolic summary 252, the decision table 253, and the trace information 254. Among these, the symbolic summary 252 corresponds to the above-described symbolic summary, which includes a terminal node of the execution tree at the time point when the symbolic-execution is terminated.

In the decision table 253, results which are obtained according to true and fault of the symbolic summary 252 are associated with conditional expressions in a table form. The decision table 253 is created by an SAT solver (SATisfiability problem solver) based on the symbolic summary 252, for example.

The trace information 254 is information indicating a transition of a variable value from one processing unit to another (hereinafter, also referred to as “processing blocks”) of the source code 251 during execution of the symbolic-execution. The trace information 254 is created corresponding to the symbolic summary 252 which is obtained by executing the symbolic-execution. The trace information 254 is described later in detail.

The source code 251 is stored in the storage device 12 after being taken into the program analysis apparatus 10 with various ways. For example, a source code is stored in the program analysis apparatus 10 from the external apparatus 2 (such as a terminal which is used for software development by a developer of software) through the communication network 5 when a developer of software or the like analyzes a developing program. Also, for example, the source code 251 is provided to the program analysis apparatus 10 through the input device 13.

The source code 251 is stored in the storage device 12 in association with an identifier (for example, a path name and file name of the source code, and hereinafter also referred to as a source code ID). Here, the identifier is given for each source code 251. The source code 251 targeted for the symbolic-execution may be the whole of the source code 251 (for example, a compilable unit) or may be a segment of the source code 251 (for example, a specific function described in the source code 251).

The change point reception part receives an input of a change point in the program though the input device 13 or the communication device 15 from a user. The user can select any one of “symbolic summary,” “source code,” and “decision table” as a change point input method.

The source code influenced segment analysis part identifies a segment of the source code 251 (hereinafter, also referred to as a source code influenced segment) which is influenced when a change is made in the program with regard to the change point received by the change point reception part based on the result of the symbolic-execution by the symbolic-execution processing part. The program processing apparatus 10 stores the identified source influenced segment as the analysis result 255 in the storage device 12.

Based on the execution result of the symbolic-execution by the symbolic-execution processing part, the symbolic summary influenced segment analysis part identifies a segment of the symbolic summary 252 (hereinafter, also referred to as a symbolic summary influenced segment) in which an influence may occur when the change is made in the program with regard to the change point received by the change point reception part. The program analysis apparatus 10 stores the identified symbolic summary influenced segment in the storage device 12 as the analysis result 255.

The source code influenced segment output part displays the source code influenced segment identified by the source code influenced segment analysis part on the display device 14.

The symbolic summary influenced segment output part displays the symbolic summary influenced segment identified by the symbolic summary influenced segment analysis part on the display device 14.

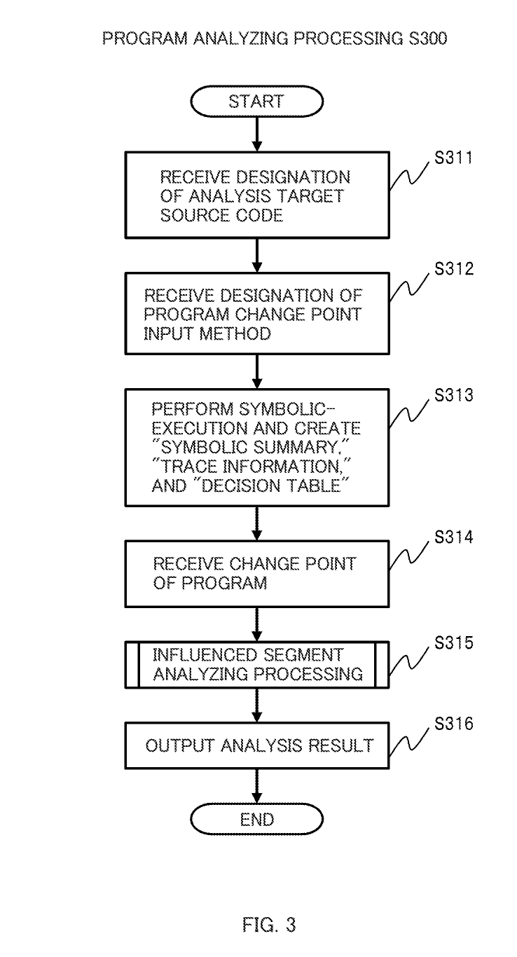

Described hereinafter is processing which is performed by the program analysis apparatus 10 (hereinafter, also referred to as program analyzing processing S300) when a modification-targeted program is analyzed in conjunction with the flowchart illustrated in FIG. 3.

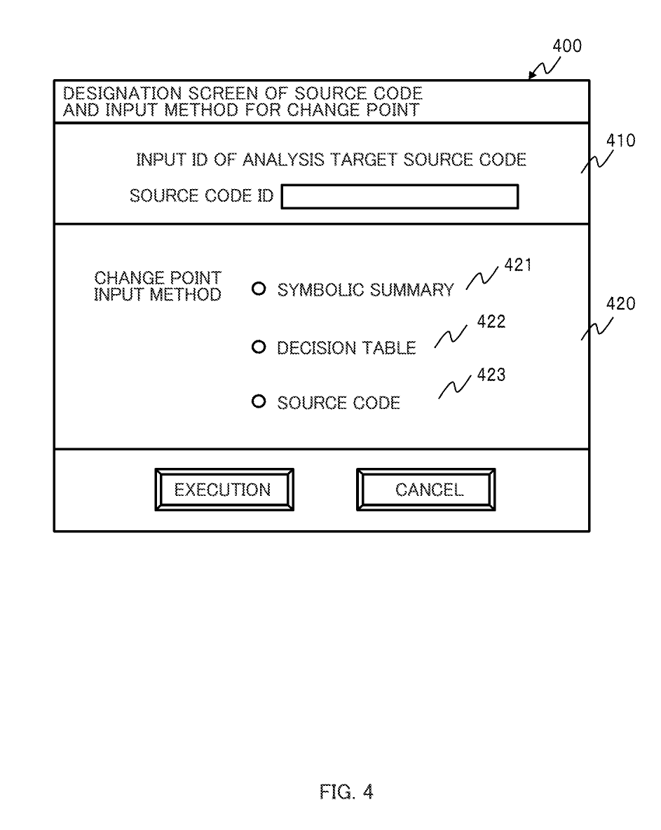

As illustrated in the flowchart, the program analysis apparatus 10 firstly displays a screen illustrated in FIG. 4, for example (hereinafter, also referred to as a designation screen 400 for a method of inputting a source code and a change point) on the display device 14, to receive the designation of a method of inputting the source code ID of the source code 251 and change point of the modification-targeted program from a user through the input device 13 or the communication network 5 (S311, S312).

Then, the program analysis apparatus 10 performs the symbolic-execution on the source code 251 received at S311 and creates the symbolic summary 252, the trace information 254, and the decision table 253 (S314).

After that, the program analysis apparatus 10 receives an input of the change point according to the change point input method designated at S312 (S314).

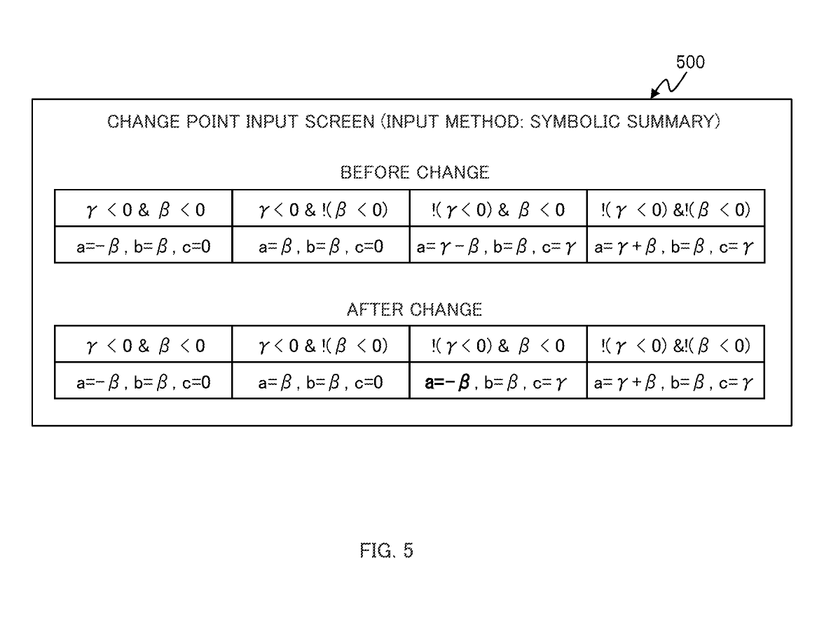

FIG. 5 illustrates an example of the screen (hereinafter, also referred to as a change point input receiving screen (symbolic summary) 500) which is displayed by the program analysis apparatus 10 on the display device 14 when the “symbolic summary” is selected as the change point input method (when the symbolic summary 421 is selected in FIG. 4) and receives an input of the change point. The user can input the change point by modifying (such as adding, changing, or deleting) the content of the symbolic summary (path constraints (upper field), the variable states (lower field)) “after change” in FIG. 5. In this example, the program analysis apparatus 10 receives an input of the change point with the modification on the symbolic summary assuming that the variable states (lower field) of the symbolic summary in which the path constraint (upper field) is “!(γ<0) & β<0” is changed from “a=γ−β”to “a=−β”(portion highlighted in FIG. 5).

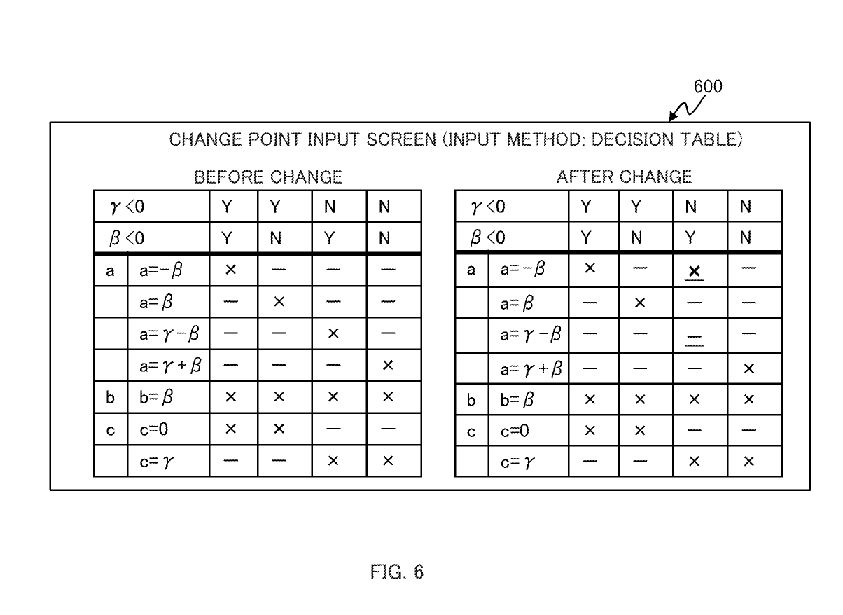

FIG. 6 illustrates an example of a screen (hereinafter, also referred to as a change point input receiving screen (decision table) 600) which is displayed on the display device 14 by the program analysis apparatus 10 when the “decision table” is selected as the change point input method (when the decision table 422 is selected in FIG. 4) and receives an input of the change point. The user inputs the change point by modifying (such as adding, changing, or deleting) the content of the decision table of the “after the change” in FIG. 6. In this example, the program analysis apparatus 10 receives an input of the change point corresponding to the modification on the decision table, assuming that the variable states (lower field) of the symbolic summary in which the path constraint (upper field) is “!(γ<0) & β<0” is changed from “a=γ−β”to “a=−β” (portion highlighted in FIG. 6).

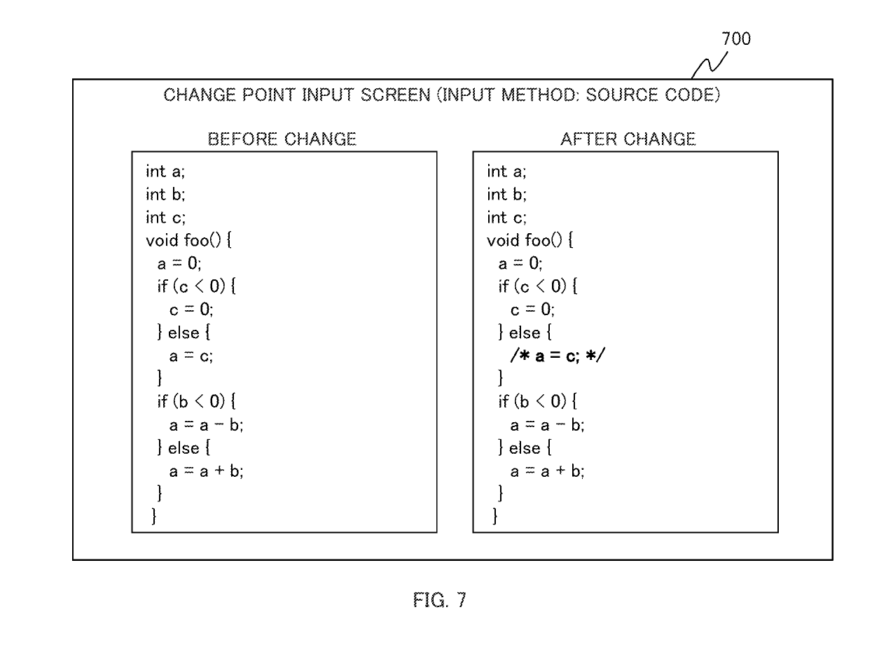

FIG. 7 illustrates an example of a screen (hereinafter, also referred to as a change point input receiving screen (source code) 700) which is displayed on the display device 14 by the program analysis apparatus 10 when the “source code” is selected as the change point input method (when the source code 423 is selected in FIG. 4) and receives an input of the change point. The user inputs the change point by modifying (such as adding, changing, or deleting) the content of the source code of the “after the change” in FIG. 7. In this example, the program analysis apparatus 10 receives an input of the change in which the source code before the change “a=c;” is commented out to “/*a=c; */”(portion highlighted in FIG. 7).

After that, the program analysis apparatus 10 identifies the above-described source code influenced segment and symbolic summary influenced segment with respect to the change point received at S313 based on the source code 251, the created symbolic summary 252 and the trace information 254 (S315). Here, both of the source code influenced segment and the symbolic summary influenced segment are not necessarily identified, but any one of them may be identified. This processing will be described in detail later.

Then, the program analysis apparatus 10 displays the analysis result (such as the source code influenced segment or the symbolic summary influenced segment) on the display device 14 (S316). With this, the program analyzing processing S300 terminates.

### Trace Information

Described is the trace information 254 which is created by the program analysis apparatus 10 at S313. The program analysis apparatus 10 creates trace information 254 based on the information which is obtained in the process of the symbolic-execution.

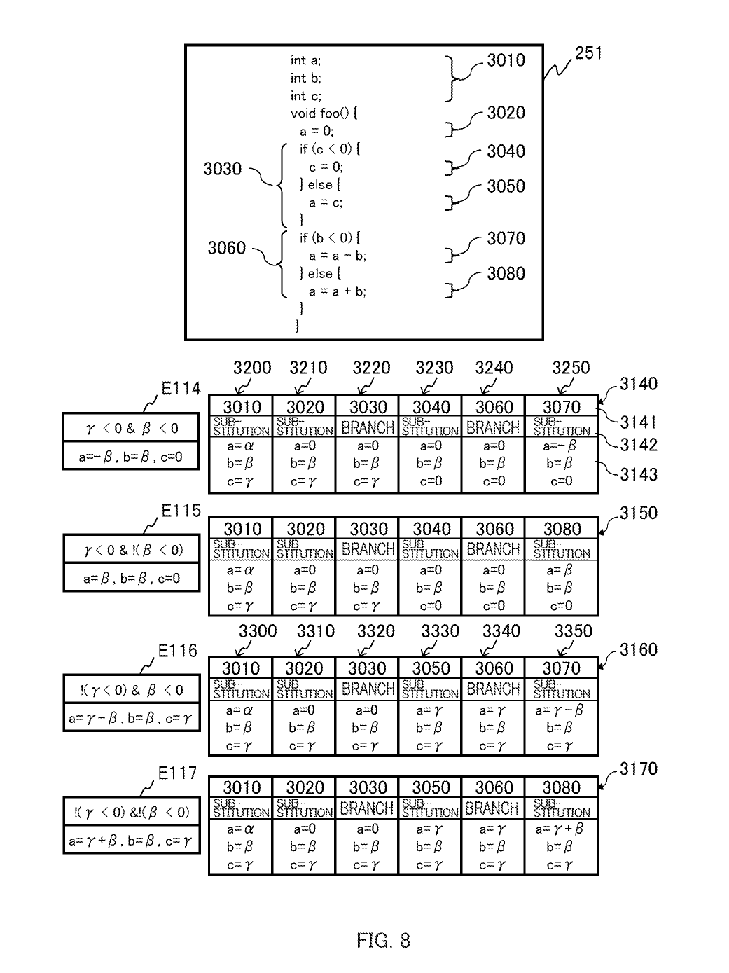

FIG. 8 illustrates an example of the trace information 254.

The source code 251 illustrated in FIG. 8 is same as the source code E101 illustrated in FIG. 1. Reference numerals E114 to E117 are the terminal nodes, in other words, the symbolic summaries of the execution tree illustrated in FIG. 1. A group of tables illustrated by reference numerals 3140 to 3170 in FIG. 8 is the trace information 254 based on the source code 251.

In FIG. 8, the trace information 3140 is the trace information 254 corresponding to the symbolic summary E114, the trace information 3150 is the trace information 254 corresponding to the symbolic summary E115, the trace information 3160 is the trace information 254 corresponding to the symbolic summary E116, and the trace information 3170 is the trace information 254 corresponding to the symbolic summary E117.

As illustrated in FIG. 8, each piece of the trace information 3140 to 3170 includes elements (hereinafter, also referred to as “trace elements”) corresponding to the processing blocks of the source code 251. A trace element has items of a block number 3141 which is a number uniquely given to each processing block, the processing content 3142 of the processing block (in the example, the processing content includes “substitution” and “branch”), and variable value 3143 after processing in the processing block. It is to be noted that the program analysis apparatus 10 adds “index” as an identifier of each trace element to the trace element, and thereby identifies each of the trace elements.

In FIG. 8, for example, the trace element 3200 corresponds to the processing block of the block number “3010” of the source code 251, and has the processing content 3141 as “substitution” and “a=α, b=β, c=γ” as the variable values. Also, for example, the trace element 3240 corresponds to the processing block of the block number “3060” of the source code 251 and has the processing content 3141 as “branch” and “ a=0, b=β, c=0” as the variable values.

### Influenced segment Analyzing Processing

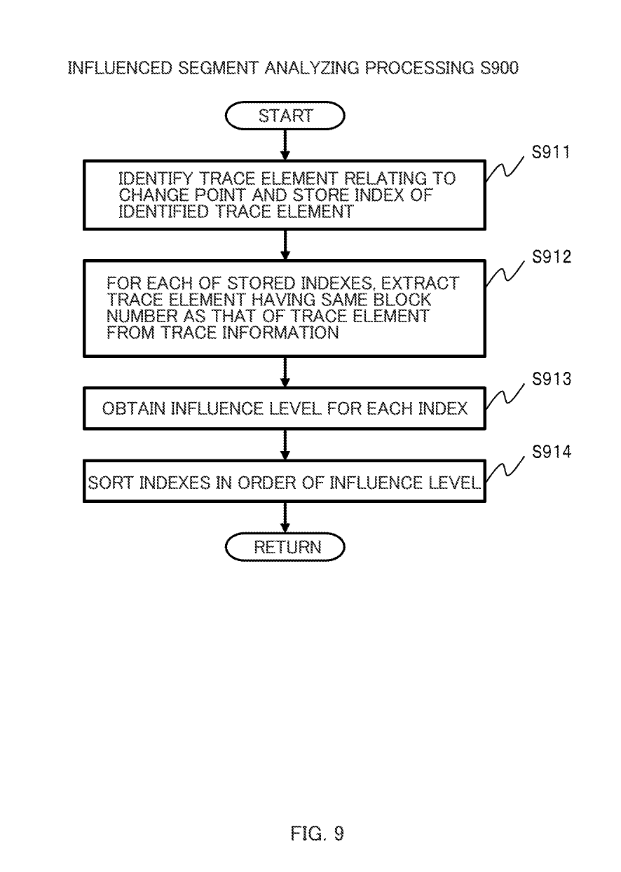

FIG. 9 is a flowchart illustrating the influenced segment analyzing processing S315 in the program analyzing processing S300 in FIG. 3. Hereinafter, the influenced segment analyzing processing S315 is described in detail in conjunction with FIG. 9.

For the change point received at S314 in FIG. 3, the program analysis apparatus 10 firstly identifies the trace element relating to the change point from the trace information 254 created at S313 in FIG. 3 and stores the index of the identified trace element (S911). The trace element relating to the change point, for example, includes a trace element A whose processing content is “substitution” for a variable designated as the change point and a trace element B whose processing content is “branch” or “substitution” of the trace elements corresponding to the processing executed before the processing corresponding to the trace element A is executed.

Then, targeting each of the indexes stored at 5911, the program analysis apparatus 10 searches all the pieces of trace information 254 created at S313 in FIG. 3 to retrieve the trace element having the same block number as that of the trace element with the target index (S912), and obtains an influence level (number of influenced segments) due to a change in the program for the change point received at S314 in FIG. 3, based on the number of the trace elements retrieved (S913). After that, the program analysis apparatus 10 sorts the indexes stored in the order of obtained influence level (for example, in the ascending order of the influence level) (S914). The influence level is an index indicating the size of the influence on the program which may occur when the program is changed for the change point.

Specifically described are the influenced segment analyzing processing S315 and the display processing S316 of the analysis result in FIG. 3. It is assumed in the following description that all of the source code 251, the symbolic summary 252, and the trace information 254 are the same contents illustrated in FIG. 8. Also, it is assumed that the “symbolic summary” is designated as the change point input method for the program at S312 in FIG. 3, and it is assumed at S314 in FIG. 3 to receive an input in which the variable state “a=γ−β” corresponding to the path constraint “!(γ<0) & β<0” is “a=−β” as illustrated in FIG. 5.

Firstly, for the change point received at S314 in FIG. 3, the program analysis apparatus 10 identifies the trace element relating to the change point from the trace information 254 created at S313 in FIG. 3, and stores the index of the identified trace element (S911).

Here, the program analysis apparatus 10 identifies the trace element (corresponding to the above-described trace element A) whose processing content is “substitution” for the variable “a” designated as the change point and whose index of the trace information 3160 is “3350” and stores the index “3350” of the trace element, as the trace element corresponding to the change point. Also, among the upper trace elements of the identified trace element A, the program analysis apparatus 10 identifies the trace element (corresponding to the above-described trace element B) whose processing content is “branch” and whose index is “3340” and stores the index “3340.”

Also, among the upper trace elements of the identified trace element A, the program analysis apparatus 10 identifies the trace element (corresponding to the above-described trace element B) whose processing content is “substitution” and whose index is “3330” and stores the index “3330.”

Also, among the upper trace elements of the identified trace element A, the program analysis apparatus 10 identifies the trace element (corresponding to the above-described trace element B) whose processing content is “branch” and whose index is “3320” and stores the index “3320.”

Subsequently, targeting each of the indexes stored at 5911, the program analysis apparatus 10 searches all the pieces of the trace information 3140 to 3170 to retrieve the trace element having the same block number as that of the trace element of the stored index (S912) , and obtains an influence level for each of the stored indexes based on the number of the trace elements retrieved as a result of the search (S913).

The trace elements having the same block number as “3070” which is the block number of the trace element whose index is “3350” are included in two pieces of the trace information 254 of the trace information 3140 and the trace information 3160. Accordingly, the program analysis apparatus 10 sets the influence level as “2” for the index “3350.”

Also, since the processing content 3142 of the trace element whose index is “3340” is “branch,” the program analysis apparatus 10 adds the total number of trace elements which are lower than the trace element having the block number “3060” (the concerned trace element and a trace element corresponding to processing to be executed after execution of the processing corresponding to the concerned trace element) to the influence level for each piece of the trace information including the trace element having the block number “3060.” In other words, the program analysis apparatus 10 sets “2” for the trace information 3140, “2” for the trace information 3150, and “2” for the trace information 3160, and “2” for the trace information 3170, and adds these up to make the influence level as “2+2+2+2=8” for the trace element with the index “3340.”

Also, the processing content 3142 of the trace element whose index is “3330” is “substitution” and the trace element having the same block number “3050” is included in the two of the trace information 3160 and the trace information 3170. Accordingly, the program analysis apparatus 10 sets “2” as the influence level for the index “3330.”

Also, since the processing content 3142 of the trace element whose index is “3320” is “branch,” the program analysis apparatus 10 adds the total number of trace elements which are lower than the trace element having the block number “3030” to the influence level for each piece of the trace information including the trace element having the block number “3030.” In other words, the program analysis apparatus 10 sets “4” for the trace information 3140, “4” for the trace information 3150, and “4” for the trace information 3160, and “4” for the trace information 3170, and adds these up to make the influence level as “4+4+4+4=16” for the trace element with the index “3320.”

Then, the program analysis apparatus 10 compares the extents of influence of the indexes obtained as described above and sorts the stored indexes in the order of the influence level (S914). In the example, the program analysis apparatus 10 sorts the indexes in the ascending order of the influence level, in other words, in the order of “3350,” “3330,” “3340,” and “3320.”

### Analysis result Display Screen

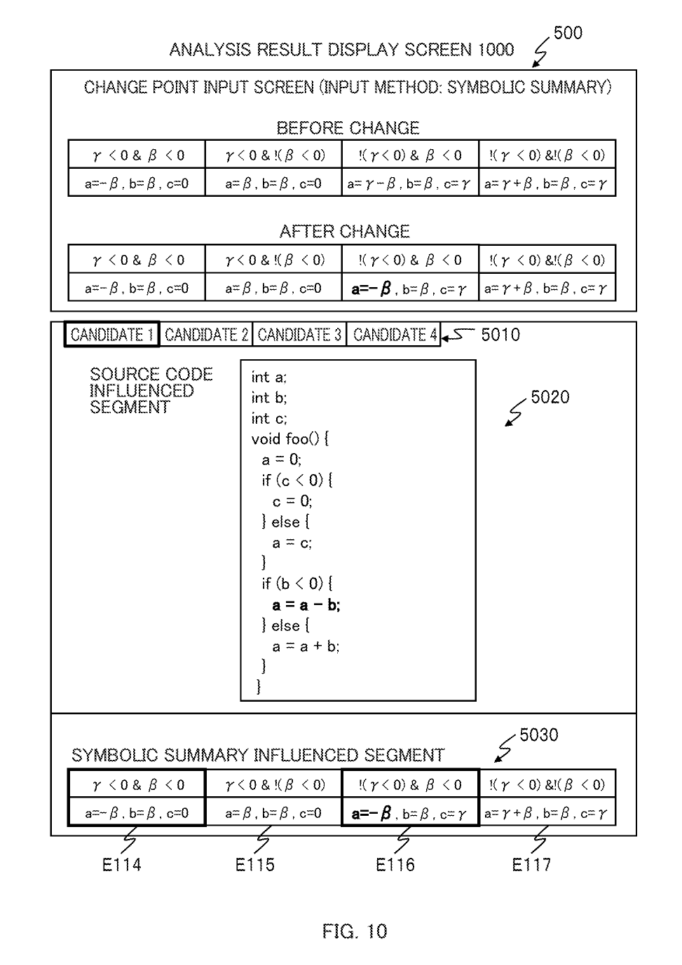

FIGS. 10 to 13 illustrate example screens (hereinafter, also respectively referred as analysis result display screens 1000 to 1300), each of which is caused by the program analysis apparatus 10 to be displayed on the display device 14 as an analysis result at 5316 in FIG. 3. A user operates a candidate selection field 5010 provided in each of the analysis result display screens 1000 to 1300, so that the display can be switched among the screens of FIGS. 10 to 13. The order of “candidate 1” to “candidate 4” in the candidate selection field 5010 corresponds to the result of sorting at 5914 in FIG. 9.

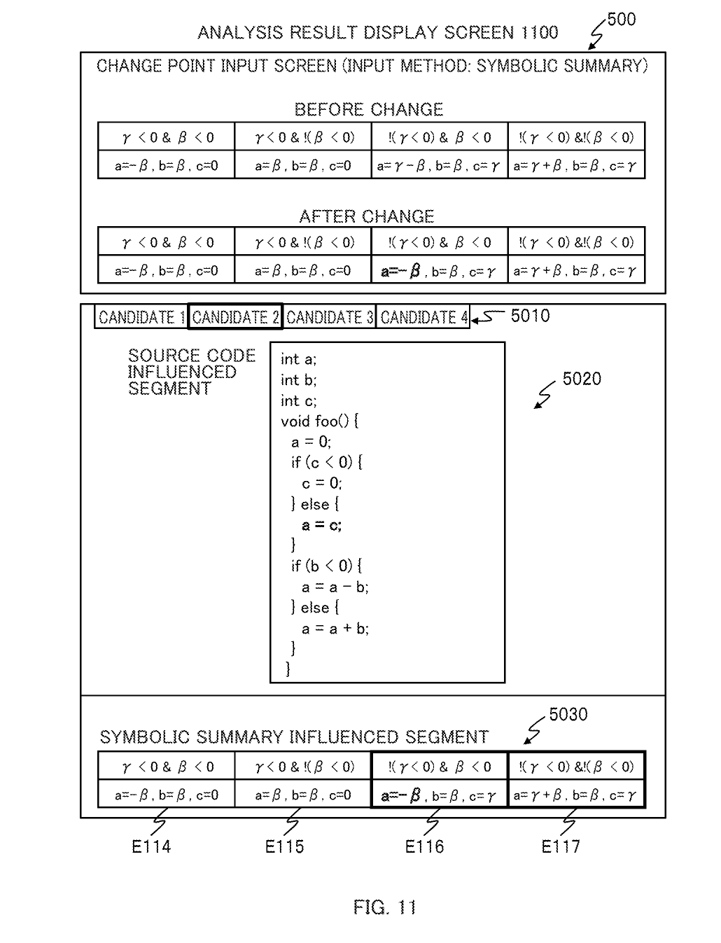

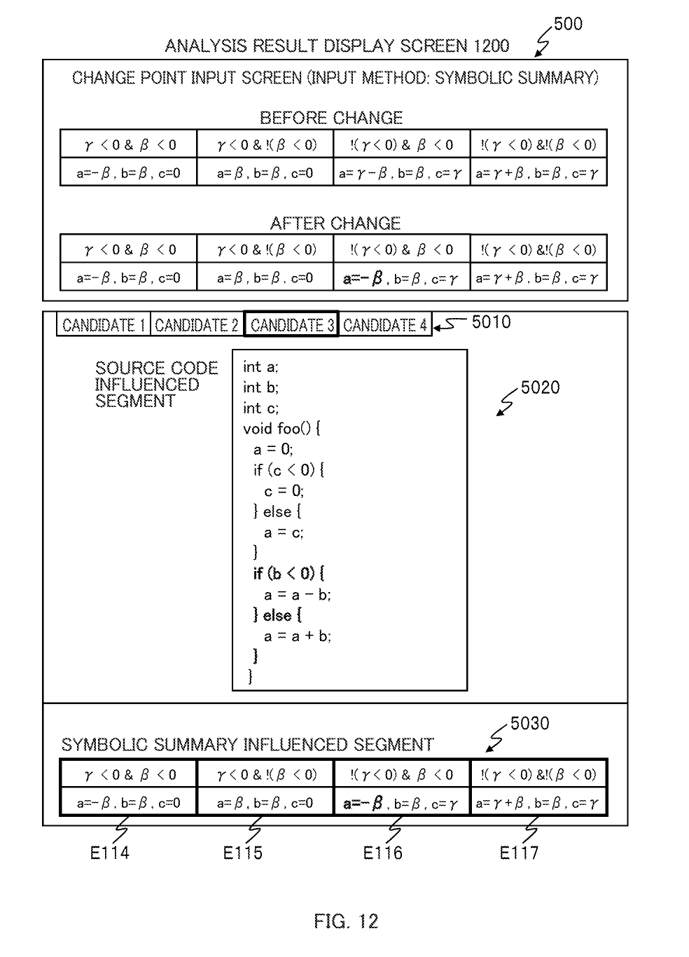

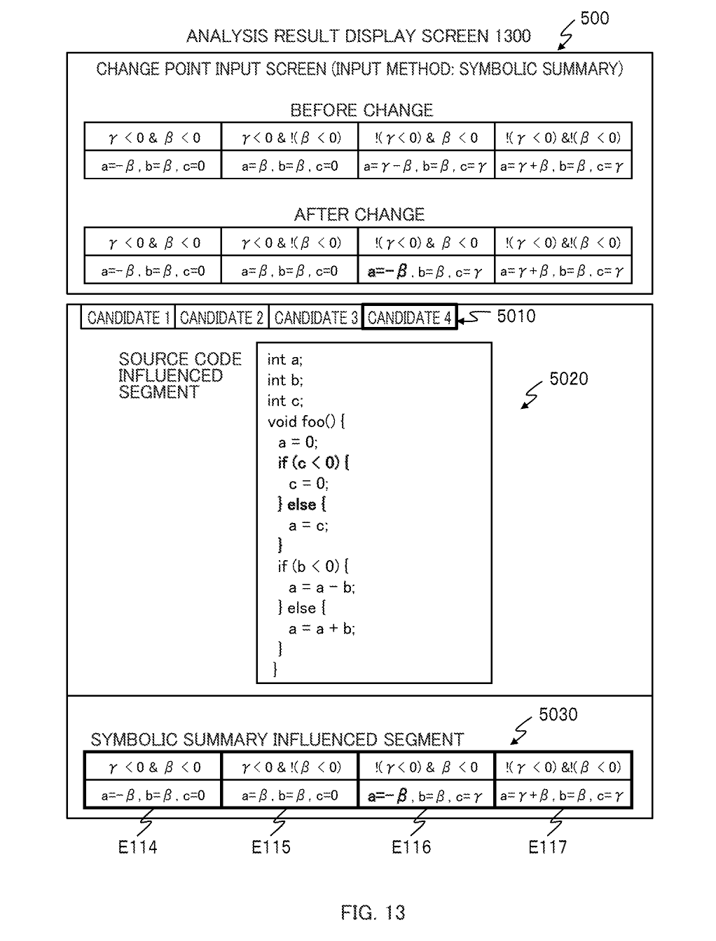

FIG. 10 is the screen (analysis result display screen 1000) which is displayed when the “candidate 1” is selected in the candidate selection field 5010, which corresponds to the trace element whose index is “3350.” FIG. 11 is the screen (analysis result display screen 1100) which is displayed when the “candidate 2” is selected, which corresponds to the trace element whose index is “3330.” FIG. 12 is the screen (analysis result display screen 1200) which is displayed when the “candidate 3” is selected, which corresponds to the trace element whose index is “3340.” FIG. 13 is the screen (analysis result display screen 1300) which is displayed when the “candidate 4” is selected, which corresponds to the trace element whose index is “3320.”

The source code influenced segments identified by the indexes “3350,”“3330,”“3340,” and “3320” stored at 5911 in FIG. 9 are highlighted in the respective display fields 5020 of the analysis result display screens 1000 to 1300. Also, the symbolic summary influenced segments identified from the above-described indexes are highlighted in the respective display fields 5030 of the analysis result display screens 1000 to 1300.

For example, since the block number of the block element having the index “3350” is “3070” as shown in FIG. 8, in the analysis result display screen 1000 illustrated in FIG. 10, a segment of “a=a−b ;” of the source code is highlighted by bold letters as the source code influenced segment, which corresponds to the block number “3070.” Also, the block element of the block number “3070” is included in the trace information 3140, 3160 as illustrated in FIG. 8. Accordingly, in the analysis result display screen 1000, the symbolic summaries E114, E116 corresponding to the information are highlighted by thick frame line as the symbolic summary influenced segments.

Also, for example, since the block number of the block element having the index “3330” is “3050” as shown in FIG. 8, in the analysis result display screen 1100 illustrated in FIG. 11, a segment of “a=c;” of the source code is highlighted by bold letters as the source code influenced segment, which corresponds to the block number “3050.” Also, the block element of the block number “3050” is included in the trace information 3160, 3170 as illustrated in FIG. 8. Accordingly, in the analysis result display screen 1100, the symbolic summaries E116, E117 corresponding to the information are highlighted by thick frame line as the symbolic summary influenced segments.

Also, for example, since the block number of the block element having the index “3340” is “3060” as shown in FIG. 8, in the analysis result display screen 1200 illustrated in FIG. 12, a segment of “if (b <0) {,″″} else {, ″and ″}” of the source code is highlighted by bold letters as the source code influenced segment, which corresponds to the block number “3060.” Also, the block element of the block number “3060” is included in the trace information 3140 to 3170 as illustrated in FIG. 8. Accordingly, in the analysis result display screen 1200, the symbolic summaries E114 to E117 corresponding to the information are highlighted by thick frame line as the symbolic summary influenced segments.

Also, for example, since the block number of the block element having the index “3320” is “3030” as shown in FIG. 8, in the analysis result display screen 1300 illustrated in FIG. 13, a segment of “if (c<0) {, ″″else {, ″and ″}” of the source code is highlighted by bold letters as the source code influenced segment, which corresponds to the block number “3030.” Also, the block element of the block number “3030” is included in the trace information 3140 to 3170 as illustrated in FIG. 8. Accordingly, in the analysis result display screen 1300, the symbolic summaries E114 to E117 corresponding to the information are highlighted by thick frame line as the symbolic summary influenced segments.

It is to be noted that the embodiments of displaying the analysis results are not limited to the ones described above. For example, a highlighting method may be hatching, underline, italic, font change, letter color change, or the like. Also, in FIGS. 10 to 13, the change point, the source code influenced segment, and the symbolic summary influenced segment are displayed on one screen. However, the embodiments are not limited. For example, they may be displayed individually or by another combination.

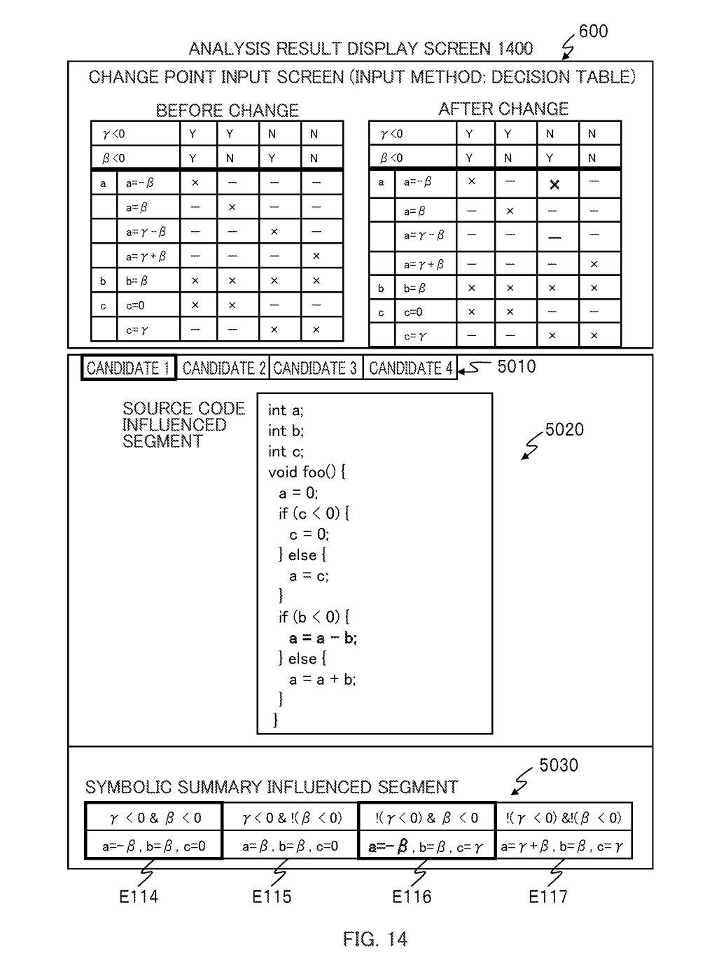

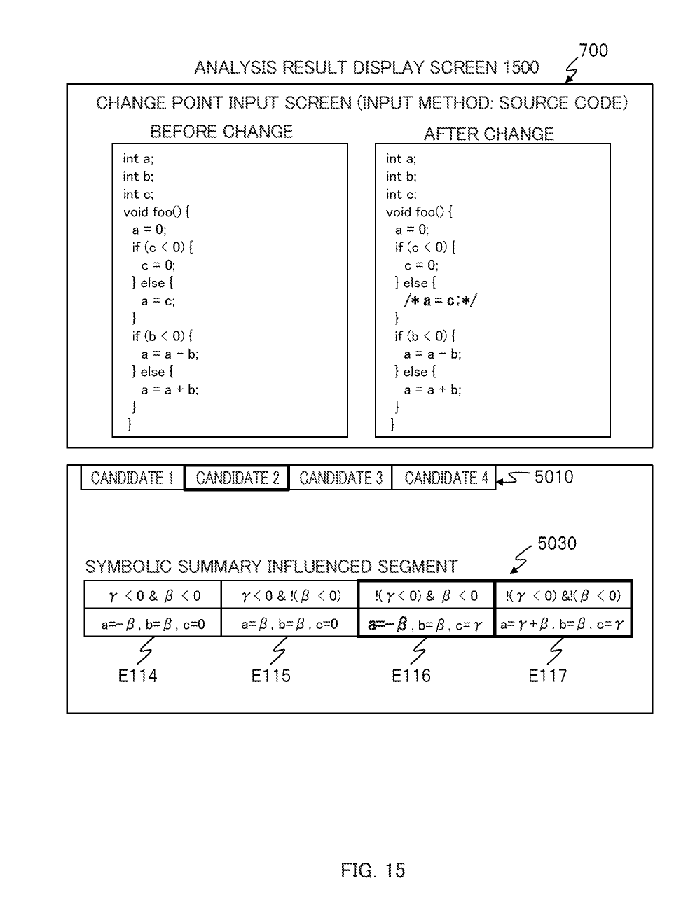

Described in the above description as an example is the case where the symbolic summary 421 is designated as the change point input method in the designation screen 400 for the method of inputting the source code and the change point, illustrated in FIG. 4. However, when the decision table 422 is designated as the change point input method, the program analysis apparatus 10 displays the analysis result display screen 1400 as illustrated in FIG. 14, for example. Also, when the source code 423 is designated as the change point input method, the program analysis apparatus 10 displays the analysis result display screen 1500 as illustrated in FIG. 15, for example, on the display device 14. Here, an influenced segment of the decision table may be further displayed in the analysis result display screen 1500.

As described above, the program analysis apparatus 10 of the present embodiment automatically identifies and quickly and properly displays (visualizes) the influenced segment of the program with respect to the inputted change point of the program. Accordingly, for example, a user can effectively and correctly examine the influenced segment (influence scope) of the program along with the modification in order to cause the existing program to correspond to the new specification. Accordingly, an efficiency of developing software and reliability of software can be improved.

Also, the program analysis apparatus 10 identifies the influenced segment of the program based on the source code, the symbolic summary, and the trace information which are obtained by the symbolic-execution, so that the influenced segment can be effectively identified. In particular, the program analysis apparatus 10 identifies the influenced segment of the program by identifying the trace element which is the trace element performing “substitution” on the variable relating to the change point and the trace element whose processing content is “branch” or “substitution” among the trace elements corresponding to the processing executed before the processing corresponding to the trace element is executed, so that the influenced segment can be correctly identified.

Also, the program analysis apparatus 10 receives an input of the change point of the program by receiving the change operation on any one of the symbolic summary, the decision table, and the source code, so that a user can be provided with a variety of user interfaces for inputting the change point. Accordingly, the user can examine the identification of the program from a variety of points and can secure the reliability of the program by preventing failures such as bugs from being included.

Also, the program analysis apparatus 10 identifies a trace element having a common processing block among the trace elements forming the trace information for each of the identified trace elements and obtains an influence level when the program is modified for the change point based on the number of the identified trace elements, and the influenced segments respectively corresponding to the identified trace elements are displayed in the order of the influence level. Accordingly, the user can select a proper program change method in consideration of each of the extents of influence in the variations of change.

It is to be noted that the present invention is not limited to the above-described embodiment and includes various modifications. For example, the above-described embodiment is described in detail with a view to describing the present invention clearly, and is not necessarily limited to the embodiment including all the configurations described above. Also, a segment of the configuration of one embodiment may be replaced by the configuration of another embodiment, and the configuration of another embodiment may be added to the configuration of one embodiment. Also, as for one part of the configuration of each embodiment, another configuration may be added, deleted, or replaced.

For example, when the change point relating to “substitution” of the variable which is used for the program is received from a user, the program analysis apparatus 10 may identify the influenced segment of the program and may automatically create a program (for example, a source code) after the change.

Also, a part or all of the above-described configurations, functions, processing parts, processing means, or the like may be achieved by hardware such that they are implemented by an integrated circuit, for example. Also, the above-described configurations or functions may be achieved by software such that a program achieving these functions can be interpreted and executed by the processor. The information such as the program, the table, the file, and the like achieving the functions may be stored in a recording device such as a memory, a hard disk or an SSD or a recording medium such as an IC card, an SD card, or a DDV.

In addition, control lines and information lines are illustrated only about ones necessary for description, which means that all of the control lines and the information lines necessary for a product are not always illustrated. It may be considered in reality that almost all configurations are coupled to one another.

What is claimed is:

1. A program analysis apparatus, comprising:
a processor;
a storage device;
a symbolic-execution processing part to execute symbolic-execution on a program stored in the storage device;
a change point reception part to receive an input of a change point of the program; and
an influenced segment analysis part to identify an influenced segment which is a segment of the program to be influenced if the program is changed for the change point, based on a result of the symbolic-execution.

2. The program analysis apparatus according to claim 1, wherein the influenced segment analysis part identifies the influenced segment based on a source code of the program, a symbolic summary configured of a terminal node of an execution tree obtained by the symbolic-execution, and trace information which is a set of trace elements acquired in a process of the symbolic-execution and being information including a processing content and a variable state for each processing block of the source code.

3. The program analysis apparatus according to claim 1, comprising an input device and a display device, wherein
symbolic-execution on the display device, and receives an input of the change point of the program by receiving a change operation on the symbolic summary from the input device.

4. The program analysis apparatus according to claim 1, comprising an input device and a display device, wherein
the change point reception part displays a decision table based on a symbolic summary which is a terminal node of an execution tree obtained by the symbolic-execution on the display device, and receives an input of a change point of the program by receiving a change operation on the decision table from the input device.

5. The program analysis apparatus according to claim 1, comprising an input device and a display device, wherein
the change point reception part displays a source code of the program on the display device and receives an input of a change point of the program by receiving a change operation on the source code from the input device.

6. The program analysis apparatus according to claim 1, comprising a display device to display at least one of a screen in which the influenced segment is shown by a symbolic summary which is a terminal node of an execution tree obtained by the symbolic-execution, a screen in which the influenced segment is shown by a source code of the program, and a screen in which the influenced segment is shown by a decision table based on the symbolic summary.

7. The program analysis apparatus according to claim 2, wherein the influenced segment analysis part identifies at least one of a trace element A being the trace element in which a substitution is made to a variable relating to the change point, and a trace element B whose processing content is a branch or substitution among trace elements corresponding to processing executed before execution of the processing corresponding to the trace element A, and identifies a segment of the program corresponding to the identified trace element as the influenced segment.

8. The program analysis apparatus according to claim 7, wherein, for each of the identified trace elements, the influenced segment analysis part identifies a trace element having a processing block common to the each trace element, among the trace elements forming the trace information, and obtains an influence level due to a modification of the program for the change point, based on the number of the identified trace elements.

9. The program analysis apparatus according to claim 8, comprising a display device, wherein
the influenced segment analysis part displays the influenced segments corresponding to the identified trace elements in an order of the influence level on the display device.

10. A program analysis method to be executed by a program analysis apparatus including a processor and a storage device, the method comprising the steps, executed by the program analysis apparatus, of:
performing symbolic-execution on a program stored in the storage device;
receiving an input of a change point of the program; and
identifying an influenced segment which is a segment of the program having a possibility of being influenced when the program is changed for the change point.

11. The program analysis method according to claim 10, wherein
the program analysis apparatus identifies the influenced segment based on a source code of the program, a symbolic summary configured of a terminal node of an execution tree acquired by the symbolic-execution, and trace information which is a set of trace elements acquired in a process of the symbolic-execution and being information including a processing content and a variable state for each processing block of the source code.

12. The program analysis method according to claim 10, wherein
the program analysis apparatus further includes an input device and a display device, and
the program analysis apparatus displays a symbolic summary which is a terminal node of an execution tree obtained by the symbolic-execution on the display device, and receives an input of a change point of the program by receiving a change operation on the symbolic summary from the input device.

13. The program analysis method according to claim 10, wherein
the program analysis apparatus further includes an input device and a display device, and
the program analysis apparatus displays a decision table based on a symbolic summary which is a terminal node of an execution tree obtained by the symbolic-execution on the display device, and receives an input of a change point of the program by receiving a change operation on the decision table from the input device.

14. The program analysis method according to claim 10, wherein
the program analyzing device further includes an input device and a display device, and
the program analysis apparatus displays a source code of the program on the display device, and receives an input of a change point of the program by receiving a change operation on the source code from the input device.

15. The program analysis method according to claim 10, wherein
the program analysis apparatus further includes a display device, and
the method further includes the step, executed by the program analysis apparatus, of displaying at least one of a screen in which the influenced segment is shown by a symbolic summary which is a terminal node of an execution tree obtained by the symbolic-execution, a screen in which the influenced segment is shown by a source code of the program, and a screen in which the influenced segment is shown by a decision table based on the symbolic summary.
